(19) United States
(12) Patent Application Publication
(10) Pub. No.: US 2010/0296725 A1
(43) Pub. Date: Nov. 25, 2010

(54) DEVICE AND METHOD FOR OBTAINING A THREE-DIMENSIONAL TOPOGRAPHY

(76) Inventor: Thomas Seiffert, Gerlingen (DE)

Correspondence Address: KENYON & KENYON LLP, ONE BROADWAY, NEW YORK, NY, 10004, US

(21) Appl. No.: 12/734,599

(22) PCT Filed: Oct. 14, 2008
(86) PCT No.: PCT/EP2008/063755

§ 371 Date: Jul. 29, 2010

(30) Foreign Application Priority Data
Nov. 22, 2007 (DE) 10 2007 056 207.3

(51) Int. Cl. G06K 9/36

(52) U.S. Cl. 382/154

(57) ABSTRACT

In a device for obtaining a three-dimensional topography of a measured object, a center axis of an illumination system is situated at an angle with respect to a recording direction of a 2D camera, and the illumination system generates a focal plane on a predetermined area of the measured object, the predetermined area being smaller than a recording area of the 2D camera. The measured object is movable relative to the 2D camera and relative to the illumination system with the aid the movement device. The 2D camera records multiple images of the measured object from various positions which are occupied due to the movement of the movement device.

### BACKGROUND OF THE INVENTION

1. Field of the Invention

The present invention relates to a device and a method for obtaining a three-dimensional topography of a measured object, using a two-dimensional (2D) camera.

2. Description of Related Art

Depth-scanning fringe projection or other three-dimensional methods are used in the related art for obtaining three-dimensional topographies of measured objects. An optical method for obtaining a three-dimensional (3D) point cloud is known, for example, from published German patent application document DE 100 56 073 A1, in which a 3D camera is used which, together with an illumination system, is moved in a direction perpendicular to the measured object and records a series of images. However, in this known method the equipment design is very bulky and complicated. The known methods also have the disadvantage that for unfavorable surface conditions, for example for round components such as screws or the like, it is difficult to determine a three-dimensional topography.

### BRIEF SUMMARY OF THE INVENTION

The device according to the present invention for obtaining a three-dimensional topography of a measured object has the advantage over the related art that a simply designed and cost-effective approach is provided via which even complex three-dimensional topographies, in particular on round components, may be detected. According to the present invention, a three-dimensional topography is obtained based on the use of structured light. According to the present invention a projection of the structured light having a low depth of focus is used, so that for a recording area of a 2D camera the recording area is larger than a focus of the projection of the structured light. Furthermore, a position of the measured object is changed at the same time, so that for multiple imagings, after movement of the measured object has been completed the points of the measured object pass through the focused area as well as the unfocused areas located at the border.

This is achieved according to the present invention due to the fact that the device includes a 2D camera, an illumination system having a light source, a structure generation element for generating structured light, and an optical device, i.e., a lens, a movement device for moving the measured object, and a computing unit. The illumination system is situated at an angle with respect to a recording direction of the 2D camera. The illumination system generates a focal plane of the structure, for example a grid, of the structure generation element in a predetermined area which is smaller than a recording area of the 2D camera. The grid is preferably oriented perpendicularly to the direction of movement. The 2D camera then records multiple images of the measured object, which is moved beneath the camera with the aid of the movement device. A computing unit then computes a three-dimensional topography from the multiple images of the 2D camera.

The design of the device according to the present invention is thus very simple, and may be provided cost-effectively. Even for unfavorable surface conditions, three-dimensional topographies of components, for example round components, may be determined. Since the illumination system is inclined at a predetermined angle with respect to the camera and to the measured object, essentially the image center of the projection of the fringes is sharply imaged in the image field of the 2D camera. The imaging of the projection is blurred toward the borders of the image. Because multiple images of the measured object are recorded, there is only a small shift from image to image, so that a point on the measured object may be present on numerous recorded images. In turn, the numerous images may thus be associated with one another. In particular, continuous data may be recorded using the device according to the present invention.

The movement device is preferably a rotation device for rotating the measured object about an axis. The rotational axis is preferably perpendicular to the recording direction of the 2D camera. According to another preferred alternative, the 2D camera is situated radially or at an angle between 0° and 90° with respect to the rotational axis. Alternatively, the movement device is a displacement device for moving the measured object laterally and linearly along an axis. The displacement device may be a movable platform or carriage, for example, on which the measured object is placed. The movement device is particularly preferably designed in such a way that the measured object is continuously movable. This allows continuous processing in particular, so that, for example, round components, continuous strip material, or the like may be easily used as measured objects.

It is further preferred that the structure generation element is a fringe grating for generating structured light on the measured object.

According to another example embodiment of the present invention, the angle between the recording direction of the 2D camera and the illumination system is between 30° and 50°, in particular 45°.

According to the method of the present invention for obtaining a three-dimensional topography of a measured object, in a first step the measured object is placed on a movement device beneath the 2D camera. Structured light is then generated on the measured object with the aid of an illumination system, the illumination system being situated at an angle with respect to a recording direction of the 2D camera. The structured light is preferably a grid projection, so that a focal plane of the grid is present only in a partial area of the recording area of the 2D camera, and is unfocused in the adjacent areas. A first image of the measured object together with the structures projected thereon is then recorded in a first position, and the measured object is then moved into a second position with the aid of the movement device, and a second image is recorded. The steps of recording an image and moving the measured object with the aid of the movement device are repeated until a predetermined number of recordings of the measured object have been obtained in various relative positions with respect to the 2D camera. The three-dimensional topology is then computed based on the recorded images.

It is further preferred in the method according to the present invention that the measured object is continuously moved. This allows continuous data recording, which is required for round components or continuous strip material, for example. Alternatively, the measured object is moved in steps, a recording being made by the 2D camera during a point in time at which the movement device is at a standstill. The steps are as small as possible, preferably a few micrometers.

The three-dimensional topography is particularly preferably computed using algorithms of the depth-scanning fringe projection or the white light interferometry. By using these algorithms, the point of the highest modulation is precisely located, and from this point the three-dimensional topography of the measured object may then be computed. The best matches of the superimposition of the individual recordings may be ensured using triggering and correlation methods.

The method according to the present invention is particularly preferably used for checking so-called “grip edges.” Such grip edges are used, for example, for joints of two metallic components, the grip edge on the first component cutting into the material of the second component. The grip edge must have a continuously precise design over its entire length, which may be checked using the method according to the present invention, for example.

### BRIEF DESCRIPTION OF THE SEVERAL VIEWS OF THE DRAWING

FIG. 1 shows a schematic illustration of a device for obtaining a three-dimensional topography according to one exemplary embodiment of the present invention.

FIG. 2 shows a schematic illustration of a movement of the measured object and the recording of multiple images according to the exemplary embodiment of the present invention.

### DETAILED DESCRIPTION OF THE INVENTION

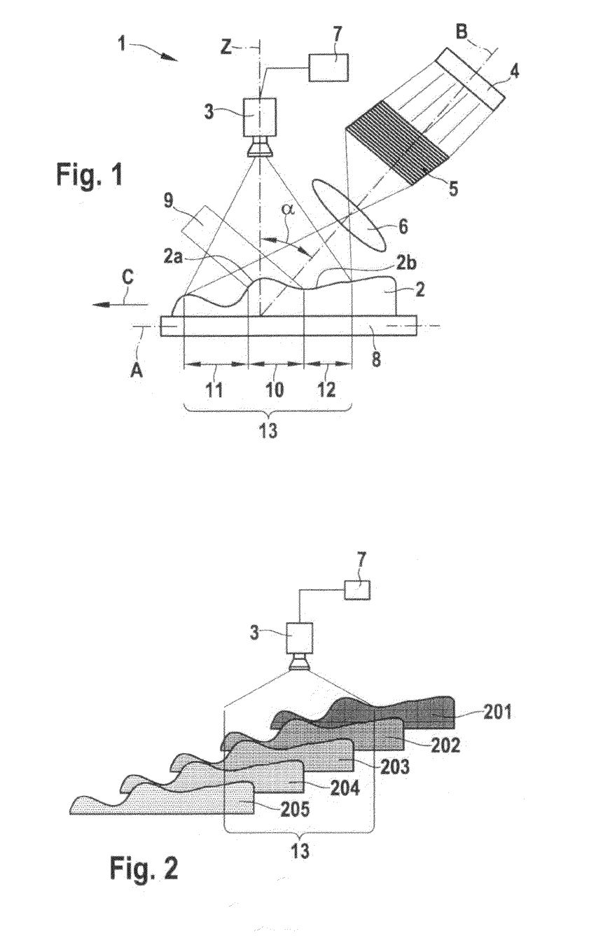

A device 1 and a method for obtaining a three-dimensional topography of a measured object 2 are described in greater detail below with reference to FIGS. 1 and 2.

As is apparent in FIG. 1, device 1 for obtaining a three-dimensional topography of a measured object 2 includes a 2D camera 3, an illumination system having a light source 4, a grid 5, and a lens 6; a computing unit 7, and a movement device 8. Measured object 2 is situated on movement device 8. Movement device 8 is able to move in the direction of an axis A, for example to the left in FIG. 1. As is apparent in FIG. 1, a center axis B of the illumination system is situated at an angle α of approximately 45° with respect to a recording direction Z of 2D camera 3. This configuration of the illumination system at an angle α with respect to recording direction Z results in a focal plane 9, which is schematically indicated in FIG. 1. This results in a focused area 10 as well as a first unfocused area 11 and a second unfocused area 12 on measured object 10 in overall recording area 13 of the 2D camera. First and second unfocused areas 11, 12 are each situated adjacent to focused area 10. Use of grid 5 thus results in a sharp imaging of the grid on measured object 2 in focused area 10, so that focused area 10 is situated approximately in the image center of recording area 13. The imaging of the grid in first and second unfocused areas 11 and 12 is blurred toward the borders of the image.

The function of device 1 according to the present invention for obtaining a three-dimensional topography of a measured object 2 is as follows. After measured object 2 is placed on movement device 8, the illumination system is switched on so that structured light in the form of a fringe grating corresponding to grid 5 is imaged on measured object 2. The grid is sharp in focused area 10, and is blurred in first and second unfocused areas 11, 12. A first imaging 201 is then carried out using 2D camera 3. A lateral movement then occurs with the aid of movement device 8, so that measured object 2 is moved by a predetermined value in the direction of arrow C in FIG. 1. An elevated area 2a of measured object 2 is thus moved slightly to the left, as indicated in FIG. 2, so that the elevated area is moved out of focal plane 9. Area 2b, which is adjacent to elevated area 2a of the measured object, then enters focal plane 9. A second image 202 is then generated using the 2D camera. The recording of images 201 through 205 is schematically illustrated in FIG. 2, measured object 2 being moved slowly from right to left. As a result, there is only a slight shift from recording to recording, so that a point on measured object 2 is present in many of recordings 201 through 205. Thus, the same points may in turn be associated with one another. The recordings are stored in a memory and then sorted in reverse order so that a point on the surface of measured object 2 may be sorted in such a way that tuning of the focus is visible. This sequence of a point may then be used to precisely locate the point of the highest or most intense modulation, using algorithms of the depth-scanning fringe projection or the white light interferometry, for example. Based on these multiple computed modulation points, the three-dimensional topography may then be computed by computing unit 7. The best match of the superimposition of individual recordings 201 through 205 may be ensured using triggering and correlation methods.

Thus, the method according to the present invention may be used to record continuous data, for example for round components such as screws or the like. According to the present invention, use is thus made of the fact that for a triangulation system of a gridded fringe projection having a low depth of focus, the focus of the fringes as well as a lateral position of measured object 2 are simultaneously changed. This is achieved using the system according to the present invention of the 2D camera, the illumination system situated at an angle with respect to the 2D camera, and movement device 8 for measured object 2.

1.-10. (canceled)

11. A device for obtaining a three-dimensional topography of a measured object, comprising:
a 2D camera;
an illumination system having a light source, a structure generation element for generating structured light, and a lens, wherein a center axis of the illumination system is situated at an angle with respect to a recording direction of the 2D camera, and wherein the illumination system generates a focal plane on a predetermined area of the measured object, the predetermined area being smaller than a recording area of the 2D camera;
a movement device on which the measured object is situated, the measured object being movable relative to the 2D camera and relative to the illumination system with the aid of the movement device, wherein the 2D camera records multiple images of the measured object at various positions which are occupied due to the movement of the movement device; and
a computing unit which computes a three-dimensional topography of the measured object from the multiple images.

12. The device as recited in claim 11, wherein the movement device is one of a rotation device configured to rotatably move the measured object or a displacement device configured to linearly move the measured object along an axis.

13. The device as recited in claim 11, wherein the movement device is configured to continuously move the measured object.

14. The device as recited in claim 11, wherein the structure generation element is a fringe grating having multiple fringes situated parallel to one another.

15. The device as recited in claim 12, wherein the angle between the recording direction of the 2D camera and the center axis of the illumination system is between 30° and 50°.

16. A method for obtaining a three-dimensional topography of a measured object, comprising:
(a) placing the measured object on a movement device beneath a 2D camera;
(b) generating structured light having a grid projection on the measured object with the aid of an illumination system having a light source, a structure generation element, and a lens, wherein a center axis of the illumination system is situated at an angle with respect to a recording direction of the 2D camera, and wherein the structured light is generated on the measured object in such a way that a focal plane on the measured object includes only a partial area of a recording area of the 2D camera;
(c) recording an image of the measured object in a selected position, using the structured light generated on the measured object;
(d) moving the measured object into a different position with the aid of the movement device;
(e) repeating steps (c) and (d) until a predetermined number of recordings of the measured object in different positions has been obtained; and
(f) computing a 3D topography based on the recorded images.

17. The method as recited in claim 16, wherein the measured object is continuously moved by the movement device.

18. The method as recited in claim 16, wherein the measured object is moved in steps, and a recording is made by the 2D camera during a standstill of the movement device.

19. The method as recited in claim 16, wherein the 3D topography is computed based on algorithms of the white light interferometry.

20. The method as recited in claim 16, wherein the measured object is moved rotationally or linearly with the aid of the movement device.
